(19) United States
(12) Patent Application Publication
(10) Pub. No.: US 2026/0238468 A1
(43) Pub. Date: Aug. 13, 2026

(54) COMMUNICATION DEVICE, COMMUNICATION METHOD, AND COMMUNICATION PROGRAM

(71) Applicant: KDDI CORPORATION, Tokyo (JP)

(72) Inventor: Shinsaku KIYOMOTO, Tokyo (JP)

(73) Assignee: KDDI CORPORATION, Tokyo (JP)

(21) Appl. No.: 19/157,012

(22) PCT Filed: Feb. 9, 2024
(86) PCT No.: PCT/JP2024/004530

§ 371 Date: Aug. 15, 2025

(30) Foreign Application Priority Data
Feb. 24, 2023 (JP) 2023-027383

(51) Int. Cl. H04L 9/08; H04L 9/32

(52) U.S. Cl. CPC H04L 9/0863; H04L 9/3226

(57) ABSTRACT

A mobile terminal provided with: a password input unit that receives, from a user, an input of a password pre-registered in a server of a communication service provider; a key generation unit that, with the password as an input, performs a prescribed computation defined by the communication service provider, thereby generating a private key in common with the communication service provider; and an authentication processing unit that, based on the private key, performs a prescribed authentication procedure with the server.

### TECHNICAL FIELD

The present invention relates to an authentication method for a terminal in a mobile communication network.

The present application claims priority on Japanese Patent Application No. 2023-027383, filed in Japan on Feb. 24, 2023, the content of which is incorporated herein by reference.

### BACKGROUND ART

Conventionally, mobile terminals such as mobile phones and smartphones are provided with security devices such as SIM or eSIM, in which long-term private keys are stored.

These long-term private keys are used during authentication and key exchange (AKA: Authentication and Key Agreement) between communication carrier networks in order to realize mobile communication services. thereby deriving encryption keys and message authentication keys (see, for example, Non-Patent Document 1).

### Citation List

### Non-Patent Documents

Non-Patent Document 1:3GPP (registered trademark) TS 23.501, System architecture for the 5G system

### SUMMARY OF INVENTION

### Technical Problem

However, in the conventional method of holding long-term private keys on security devices, for example, when a terminal is to be used on a short-term (one day, one week, etc.) usage contract, such as for a vacation or for business, it is necessary to perform procedures such as exchanging the SIM or rewriting the eSIM, requiring work and expenses until the start of use.

Therefore, a method that allows the usage of mobile terminals to be more easily started is sought.

An objective of the present invention is to provide a communication device, a communication method, and a communication program that do not require the storage of a long-term private key in a security device.

### Solution to Problem

The communication device according to the present invention is provided with: a password input unit that receives, from a user, an input of a password pre-registered in a server of a communication service provider; a key generation unit that, with the password as an input, performs a prescribed computation defined by the communication service provider, thereby generating a private key in common with the communication service provider; and an authentication processing unit that, based on the private key, performs a prescribed authentication procedure with the server.

In the communication device, the key generation unit may generate the private key with current time information, as well as the password, as inputs.

In the communication device, the current time information may be a granularity value indicating a term of validity of the password.

In the communication device, the password may be biometric information, or may be private information associated with the biometric information.

In the communication device, the designated computation may be a hash computation.

The communication method according to the present invention is a communication method by which a server of a communication service provider authenticates a communication device, the communication method involving: the server registering a user password in association with an identifier of the communication device, and generating a private key by a prescribed computation defined by the communication service provider, with the password as an input; and the communication device receiving an input of the password from the user, performing the prescribed computation with the password as an input, thereby generating the private key in common with the communication service provider, and performing a prescribed authentication procedure with the server based on the private key.

The communication program according to the present invention causes a computer to function as the communication device described above.

### Advantageous Effects of Invention

According to the present invention, the storage of a long-term private key in a security device becomes unnecessary.

### BRIEF DESCRIPTION OF DRAWINGS

FIG. 1 A block diagram illustrating a functional configuration relating to the generation of a private key in a mobile terminal in an embodiment.

FIG. 2 A sequence diagram for explaining a communication method in an embodiment.

### DESCRIPTION OF EMBODIMENTS

Hereinafter, an example of an embodiment of the present invention will be explained.

The communication method of the present embodiment involves dynamically generating a common key at both a mobile terminal and a server, based on a password input by a user, without using a private key stored in a security device on the mobile terminal when implementing authentication and key exchange by AKA in mobile communication.

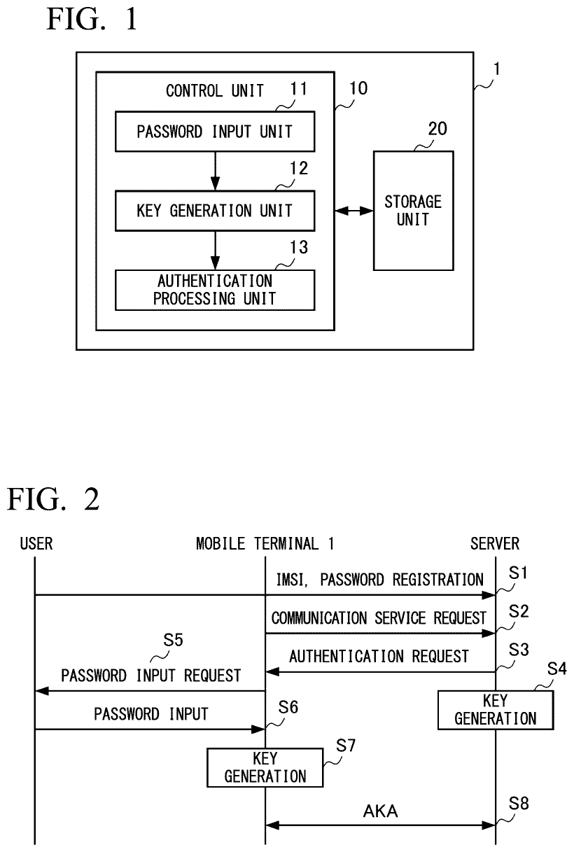

FIG. 1 is a diagram illustrating a functional configuration relating to the generation of a private key in a mobile terminal 1 (communication device) in the present embodiment.

The mobile terminal 1 is an information processing device (computer), such as a mobile phone or a smartphone, participating in a mobile communication network provided by a communication service provider. The mobile terminal 1 is provided with a control unit 10 and a storage unit 20.

The control unit 10 controls the entire mobile terminal 1. The control unit 10 realizes the respective functions in the present embodiment by appropriately reading out and executing various types of programs stored in the storage unit 20. The control unit 10 may be a CPU, or may be mounted as a dedicated hardware circuit for realizing the respective functions.

The control unit 10 is provided with a password input unit 11, a key generation unit 12, and an authentication processing unit 13.

The storage unit 20 is a storage area for various types of programs, various types of data, etc., for causing a hardware group to function as a mobile terminal 1. The storage unit 20 may be a ROM, a RAM, a flash memory, etc.

The password input unit 11 receives, from a user, an input of a password pre-registered in a server of the communication service provider.

The password may be, but is not limited to being, a text string that is decided by the user or that is automatically generated. For example, the password may be biometric information or may be private information, etc. that is associated with biometric information and that becomes usable upon successful authentication.

The key generation unit 12, with the password as an input, performs a prescribed computation defined by the communication service provider, thereby generating a private key in common with the communication service provider.

At this time, the key generation unit 12 may generate the private key with current time information, as well as the password, as inputs. The prescribed computation may be, for example, a hash computation, and in this case, the key generation unit 12 may operate a hash function with the current time information as a salt.

In this case, the current time information is a granularity value indicating the term of validity of the password.

For example, if the information is monthly information, i.e., “Year A, Month B”, with respect to a private key generated by a server with that month as the term of validity, the mobile terminal 1 can, within that month, generate a private key in common with the server. Similarly, if the information is daily, i.e., “Year A, Month B, Day C”, then a term of validity limited to one day is set, and if the information is weekly, such as “Year A, Week D”, then a term of validity limited to one week is set.

Even if the information is, for example, daily, longer terms of validity, such as one week, etc., could be handled by re-generating a private key in response to an input of a password each day.

The authentication processing unit 13 performs a prescribed authentication procedure with a server of a communication service provider based on the private key generated by the key generation unit 12.

Specifically, the authentication processing unit 13 executes an AKA authentication procedure by using the generated private key instead of a conventional long-term private key stored in a SIM.

At this time, if the aforementioned current time information is, for example, daily, then the generated private key will change when the date changes, thus no longer matching the private key held in the server, causing the authentication to automatically fail.

That is, it becomes possible to generate and collate a private key common to the mobile terminal 1 and the server only during the term of validity. Although a private key that has been successfully authenticated by the input of a password may be cached in the storage unit 20, it is deleted at the time that the term of validity expires.

FIG. 2 is a sequence diagram for explaining the communication method according to the present embodiment.

Here, the procedure performed until the mobile terminal 1 is authenticated before starting communication will be described.

In step S1, the user registers, with the server of the communication service provider, a password associated with an identifier (IMSI) of the mobile terminal 1.

In step S2, the mobile terminal 1 requests communication services from the server in response to a user operation.

In step S3, the server requests the mobile terminal 1 to implement an authentication procedure.

In step S4, the server performs a prescribed computation using the password registered in step S1, thereby generating a private key to which a term of validity has been set.

In step S5, the mobile terminal 1 requests the user to input a password.

In step S6, the user inputs, to the mobile terminal 1, the password registered in step S1.

In step S7, the mobile terminal 1 uses the password received in step S6 to generate a private key by means of a computation in common with the server.

In step S8, the mobile terminal 1 and the server complete the authentication and key exchange in accordance with the standard AKA protocol by means of the common private key generated by both.

According to the present embodiment, the mobile terminal 1 receives, from the user, an input of a password pre-registered in a server of the communication service provider, and generates a private key in common with the server by means of the prescribed computation. Thereafter, the mobile terminal 1 and the server perform authentication procedures based on this private key.

Therefore, the mobile terminal 1 uses a private key dynamically generated from a password instead of a conventional long-term private key stored in a SIM, etc. As a result thereof, the mobile terminal 1 does not need to store a long-term private key in a security device. For this reason, the user can more easily start using the mobile terminal 1. For example, even in the case of short-term usage, such as for one day or for one week, the user can easily start using the mobile terminal 1 by only setting a password, without requiring bothersome procedures such as exchanging a SIM or rewriting an eSIM.

Additionally, in the present embodiment, there are no changes to the protocol (AKA) of the authentication procedure, and modifications to conventional systems are limited. Therefore, the present embodiment can be easily implemented.

Since the mobile terminal 1 and the server generate the private key with current time information, as well as the password, as inputs, authentication succeeds only within the term of validity by collation of the private key. Therefore, a term of validity of the password can be easily set.

This current time information can be appropriately set in accordance with the length of the term of usage of the mobile terminal 1 as a granularity value indicating the term of validity of the password.

The set password may be biometric information or private information associated with biometric information. This may simplify password input by the user, increasing the convenience.

The prescribed computation for generating the private key may be a hash computation, whereby the private key can be efficiently generated and the current time information can be easily input as a salt for hashing.

Due to the present embodiment, for example, there is no need for a security device, such as a SIM card, in mobile communication. Therefore, it is possible to contribute to Goal 9, i.e., “Build resilient infrastructure, promote inclusive and sustainable industrialization and foster innovation”, of the sustainable development goals (SDGs) promoted by the United Nations.

While embodiments of the present invention have been explained above, the present invention is not limited to the aforementioned embodiments. Additionally, the effects described regarding the aforementioned embodiments are merely a listing of the most favorable effects obtained by the present invention, and the effects due to the present invention are not limited to those described in the embodiments.

The communication method due to the mobile terminal 1 may be realized by means of software. In the case of realization by software, programs constituting this software are installed in an information processing device (computer), and the above-mentioned functions are realized by executing the programs. Additionally, these programs may be distributed to users by being recorded on removable media such as CD-ROM, or may be distributed by being downloaded to the computers of users via a network. Furthermore, these programs may be provided to the computers of users as web services via a network without being downloaded.

### Reference Signs List

1 Mobile terminal (communication device)
10 Control unit
11 Password input unit
12 Key generation unit
13 Authentication processing unit
20 Storage unit

1. A communication device comprising:
a password input unit that receives, from a user, an input of a password pre-registered in a server of a communication service provider;
a key generation unit that, with the password as an input, performs a prescribed computation defined by the communication service provider, thereby generating a private key in common with the communication service provider; and
an authentication processing unit that, based on the private key, performs a prescribed authentication procedure with the server.

2. The communication device according to claim 1, wherein the key generation unit generates the private key with current time information, as well as the password, as inputs.

3. The communication device according to claim 2, wherein the current time information is a granularity value indicating a term of validity of the password.

4. The communication device according to claim 1, wherein the password is biometric information, or is private information associated with the biometric information.

5. The communication device according to claim 1, wherein the designated computation is a hash computation.

6. A communication method by which a server of a communication service provider authenticates a communication device, the communication method comprising:
the server
registering a user password in association with an identifier of the communication device, and
generating a private key by a prescribed computation defined by the communication service provider, with the password as an input; and
the communication device
receiving an input of the password from the user,
performing the prescribed computation with the password as an input, thereby generating the private key in common with the communication service provider, and
performing a prescribed authentication procedure with the server based on the private key.

7. A communication program stored on a non-transitory computer-readable medium for causing a computer to function as the communication device according to claim 1.

8. A communication program stored on a non-transitory computer-readable medium for causing a computer to function as the communication device according to claim 2.

9. A communication program stored on a non-transitory computer-readable medium for causing a computer to function as the communication device according to claim 3.

10. A communication program stored on a non-transitory computer-readable medium for causing a computer to function as the communication device according to claim 4.

11. A communication program stored on a non-transitory computer-readable medium for causing a computer to function as the communication device according to claim 5.
